(19) United States
(12) Patent Application Publication
(10) Pub. No.: US 2006/0190484 A1
(43) Pub. Date: Aug. 24, 2006

(54) System and method for client reassignment in blade server

(76) Inventors: Daryl Carvis Cromer, Apex, NC (US); Howard Jeffrey Locker, Cary, NC (US); Randall Scott Springfield, Chapel Hill, NC (US); Rod David Waltermann, Rougemont, NC (US)

Correspondence Address: ROGITZ & ASSOCIATES, 750 B STREET, SUITE 3120, SAN DIEGO, CA, 92101, US

(21) Appl. No.: 11/061,842

(22) Filed: Feb. 18, 2005

(51) Int. Cl. G06F 17/00

(52) U.S. Cl. 707/104.1

(57) ABSTRACT

When a first blade server that is servicing a client computer becomes congested, service is transferred to a second blade server potentially in a different blade center by freezing the first blade and client and then sending, to the second blade server, a pointer to the currently addressed location in the client's virtual storage and an exact memory map in the first blade server that is associated with the client computer, along with the client's IP address. These are used to reconstruct the state of the first blade in the second blade, at which time the second blade resumes service to the client.

### FIELD OF THE INVENTION

The present invention relates generally to blade servers.

### BACKGROUND OF THE INVENTION

Slim, hotswappable blade servers fit in a single chassis like books in a bookshelf. Each is an independent server, with its own processors, memory, storage, network controllers, operating system and applications. A blade server simply slides into a bay in the chassis and plugs into a mid- or backplane, sharing power, fans, floppy drives, switches, and ports with other blade servers.

The benefits of the blade approach includes obviating the need for running hundreds of cables through racks just to add and remove servers. With switches and power units shared, precious space is freed up, and blade servers enable higher density with far greater ease.

Indeed, immediate, real-life benefits make blade-server technology an important contributor to an ongoing revolution toward on-demand computing. Along with other rapidly emerging technologies (grid computing, autonomic computing, Web services, distributed computing, etc.), blade servers' efficiency, flexibility, and cost-effectiveness are helping to make computing power reminiscent of a utility service like electrical power, i.e., as much as needed for use whenever it is needed.

Blade technology is designed to help eliminate old limitations imposed by conventional server design, in which each server could accommodate only one type of processor. Each blade in a chassis is a self-contained server, running its own operating system and software. Sophisticated cooling and power technologies can therefore support a mix of blades, with varying speeds and types of processors.

As critically recognized herein, a blade server in a chassis of blade servers may accumulate client devices and their processing needs may increase service demands, and hence can become congested, degrading performance. The present invention is directed to balancing the load among blade servers.

### SUMMARY OF THE INVENTION

A method for transferring service of a client computer from a first blade server to a second blade server includes sending, from the first blade server, a client computer identifier and storage information pertaining to the client computer to the second blade server. The second blade server uses the storage information and client computer identifier to resume service to the client computer.

In some implementations, it may be desirable to freeze the client computer and first blade server, prior to the sending act. Also, a status message that the client computer has been frozen may be sent to the client computer. The method may be executed when the first blade server becomes congested as determined by a data rate or total bytes stored, or when blade failure is imminent.

The storage information can include Direct Access Storage Device information from the first blade server, and in specific implementations may include a pointer to a virtual storage associated with the client computer and an exact memory map in the first blade server that is associated with the client computer. The client computer identifier may be the IP address of the client computer. In any case, the second blade server can use the storage information to reconstruct, at the second blade server, a data storage state of the first blade server with respect to the client computer.

In another aspect, a computer system includes a first blade server servicing a client computer and a second blade server to which it is sought to transfer servicing of the client computer. Logic is provided for reconstructing, on the second blade server, the exact state of the first blade server with respect to the client computer, with the second blade server being pointed to a virtual memory associated with the client computer. In this way, the second blade server can assume, from the first blade server, servicing of the client computer.

In still another aspect, a service for transferring the servicing of a client computer from a first blade server to a second blade server includes providing means for sending storage information and client information from the first blade server to the second blade server, and providing means for using the storage information and client information to reconstruct, on the second blade server, the exact state of the client computer-dedicated portion of the first blade server. The service can also include providing means for establishing a service communication link between the client computer and the second blade server.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a front, top and right side exploded perspective view of a server blade system of the present invention;

FIG. 2 is a rear, top and left side perspective view of the rear portion of the server blade system;

FIG. 3 is a flow chart of non-limiting logic of the “old” blade;

FIG. 4 is a flow chart of non-limiting logic of the supervisor; and

FIG. 5 is a flow chart of non-limiting logic of the “new” blade.

### DETAILED DESCRIPTION OF THE PREFERRED EMBODIMENT

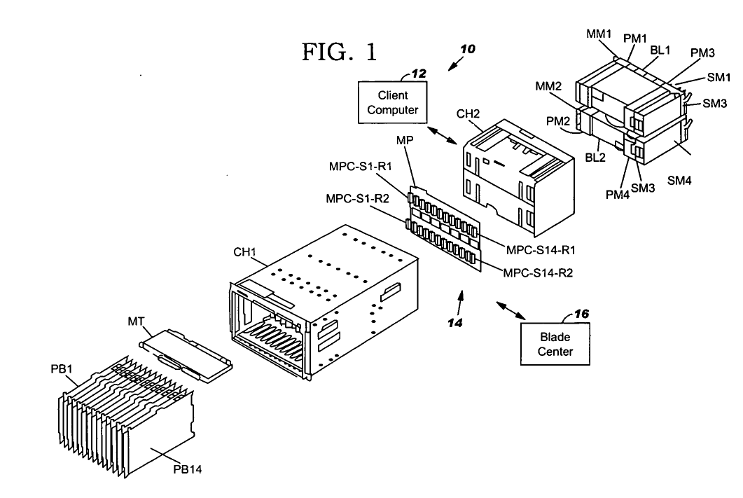

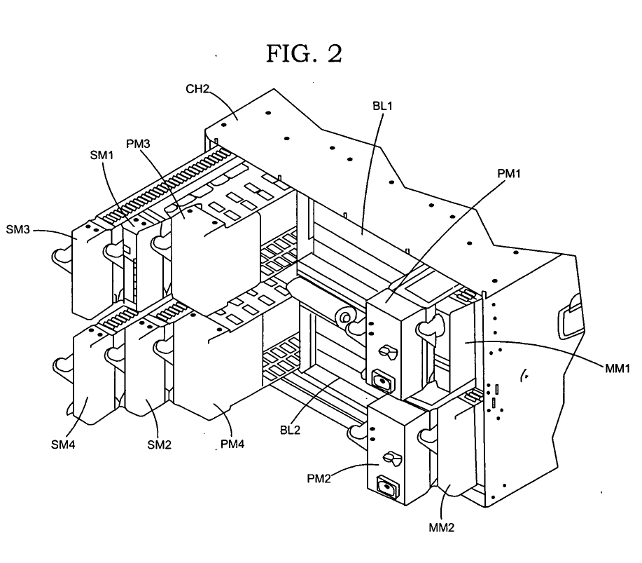

The present assignee's U.S. Pat. No. 6,771,499, incorporated herein by reference, sets forth one non-limiting blade server system with which the present invention can be used. For convenience, FIGS. 1 and 2 show such a system, generally designated 10, in which one or more client computers 12 communicate over wired or wireless paths with a blade server center, generally designated 14. The present invention may be used to balance loads among blades in a single blade center or among blades distributed in plural, potentially identical blade centers, each with its own blade server chassis. FIG. 1 for instance shows a second blade center 16 that is in all essential respects identical in configuration and operation to the blade center 14 and that communicates therewith. Any appropriate computing device may function as the client computer.

Accordingly, focusing on a non-limiting implementation of the first blade center 14, a main chassis CH1 houses all the components of the server blade center 14. Up to fourteen or more processor blades PB1 through PB14 (or other blades, such as storage blades) are hot-pluggable into the fourteen slots in the front of chassis CH1. The term “server blade”, “processor blade”, or simply “blade” are used interchangeably herein, but it should be understood that these terms are not limited to blades that only perform “processor” or “server” functions, but also include blades that perform other functions, such as storage blades, which typically include hard disk drives and whose primary function is data storage.

Processor blades provide the processor, memory, hard disk storage and firmware of an industry standard server. In addition, they include keyboard, video and mouse (“KVM”) selection via a control panel, an onboard service processor, and access to the floppy and CD-ROM drives in the media tray. A daughter card is connected via an onboard PCI-X interface and is used to provide additional high-speed links to switch modules SM1-4. Each processor blade also has a front panel with five LED's to indicate current status, plus four push-button switches for power on/off, selection of processor blade, reset, and NMI for core dumps for local control.

Blades may be “hot swapped” without affecting the operation of other blades in the system. A server blade is typically implemented as a single slot card (394.2 mm by 226.99 mm); however, in some cases a single processor blade may require two slots. A processor blade can use any microprocessor technology as long as it compliant with the mechanical and electrical interfaces, and the power and cooling requirements of the server blade system.

For redundancy, processor blades have two signal and power connectors; one connected to the upper connector of the corresponding slot of midplane MP, and the other connected to the corresponding lower connector of the midplane. Processor blades interface with other components in the server blade system via the following midplane interfaces: 1) Gigabit Ethernet (two per blade; required); 2) Fibre Channel (two per blade; optional); 3) management module serial link; 4) VGA analog video link; 4) keyboard/mouse USB link; 5) CD-ROM and floppy disk drive (“FDD”) USB link; 6) twelve VDC power; and 7) miscellaneous control signals. These interfaces provide the ability to communicate to other components in the server blade system such as management modules, switch modules, the CD-ROM and the FDD. These interfaces are duplicated on the midplane to provide redundancy. A processor blade typically supports booting from the media tray CDROM or FDD, the network (Fibre channel or Ethernet), or its local hard disk drive.

A media tray MT includes a floppy disk drive and a CD-ROM drive that can be coupled to any one of the blades. The media tray also houses an interface board on which is mounted interface LED's, a thermistor for measuring inlet air temperature, and a four-port USB controller hub. System level interface controls consist of power, location, over temperature, information, and general fault LED's and a USB port.

Midplane circuit board MP is positioned approximately in the middle of chassis CH1 and includes two rows of connectors; the top row including connectors MPC-S1-R1 through MPC-S14-R1, and the bottom row including connectors MPC-S1-R2 through MPC-S14-R2. Thus, each one of the blade slots includes one pair of midplane connectors located one above the other (e.g., connectors MPC-S1-R1 and MPC-S1-R2) and each pair of midplane connectors mates to a pair of connectors at the rear edge of each processor blade (not visible in FIG. 1).

FIG. 2 is a rear, top and left side perspective view of the rear portion of the server blade system. Referring to FIGS. 1 and 2, a chassis CH2 houses various hot plugable components for cooling, power, control and switching. Chassis CH2 slides and latches into the rear of main chassis CH1.

Two hot plugable blowers BL1 and BL2 include backward-curved impeller blowers and provide redundant cooling to the server blade system components. Airflow is from the front to the rear of chassis CH1. Each of the processor blades PB1 through PB14 includes a front grille to admit air, and low-profile vapor chamber based heat sinks are used to cool the processors within the blades. Total airflow through the system chassis is about three hundred cubic feet per minute at seven-tenths inches H2O static pressure drop. In the event of blower failure or removal, the speed of the remaining blower automatically increases to maintain the required air flow until the replacement unit is installed. Blower speed control is also controlled via a thermistor that constantly monitors inlet air temperature. The temperature of the server blade system components are also monitored and blower speed will increase automatically in response to rising temperature levels as reported by the various temperature sensors.

Four hot plugable power modules PM1 through PM4 provide DC operating voltages for the processor blades and other components. One pair of power modules provides power to all the management modules and switch modules, plus any blades that are plugged into slots one through six. The other pair of power modules provides power to any blades in slots seven through fourteen. Within each pair of power modules, one power module acts as a backup for the other in the event the first power module fails or is removed. Thus, a minimum of two active power modules are required to power a fully featured and configured chassis loaded with fourteen processor blades, four switch modules, two blowers, and two management modules. However, four power modules are needed to provide full redundancy and backup capability. The power modules are designed for operation between an AC input voltage range of 200VAC to 240VAC at 50/60 Hz and use an IEC320 C14 male appliance coupler. The power modules provide +12VDC output to the midplane from which all server blade system components get their power. Two +12VDC midplane power buses are used for redundancy and active current sharing of the output load between redundant power modules is performed.

Management modules MM1 through MM4 are hot-pluggable components that provide basic management functions such as controlling, monitoring, alerting, restarting and diagnostics. Management modules also provide other functions required to manage shared resources, such as the ability to switch the common keyboard, video, and mouse signals among processor blades.

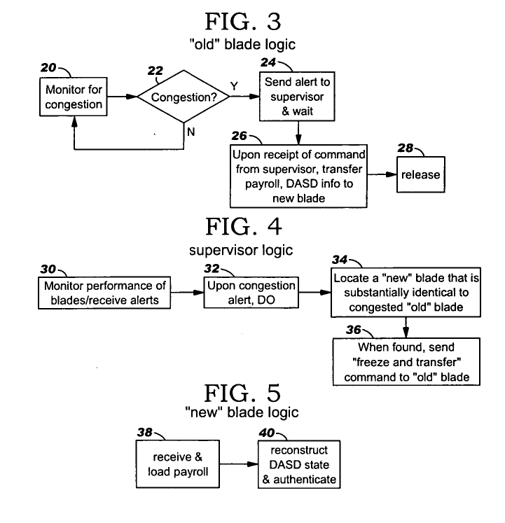

Having reviewed one non-limiting blade server system 14, attention is now directed to FIGS. 3, which shows the logic that can be executed by a processor or processors in what can be thought of as an “old” blade, i.e., a blade that experiences congestion and must transfer work to a “new”, uncongested blade in accordance with logic herein. The logic of FIGS. 3-5 may be executed by one or a combination of a blade processor, supervisor processor, and/or other processor, and the logic may stored on a data storage device such as but not limited to a hard disk drive or solid state memory device.

Commencing at block 20 of FIG. 3, each blade (including the “old” blade) monitors itself (or it sends monitoring information to the supervisor discussed below) for congestion. Congestion may be determined by a data rate threshold being exceeded, and/or by a total bytes stored threshold being exceeded, and/or by other metric, and/or by indications (such as high temperature, high noise or vibration, etc.) of impending failure or required maintenance (e.g., after the elapse of a threshold number of operating hours). If congestion is determined at decision diamond 22, a congestion alert is sent to a supervisor processor in the blade center 14 at block 24. The “old” blade then waits for further instructions.

Block 26 indicates that when a command is received at the “old” blade from the supervisor to transfer, the “old” blade sends a payroll message to the “new” blade discussed below, and freezes client computer operation. The payroll message includes information pertaining both to the client computer and to the associated Direct Access Storage Device (DASD, e.g., a hard disk drive) in the blade server center 14 that is being used to service the client computer 12. In specific embodiments the blade center storage information sent in the “payroll” may include a pointer to the currently-addressed location in the client computer's virtual storage in the congested blade and the exact current memory map in the congested blade that is associated with the client computer, while the client information may include the IP address of the client computer 12. Upon transfer, the “old” blade can be released at block 28.

FIG. 4 illustrates the logic that can be followed by one or more supervisor processors in the blade center 14, which can be implemented by a dedicated blade processor if desired. At block 30, the performance of blades is monitored, including the receipt of any congestion alerts. If a congestion alert is received, a DO loop is entered at block 32, upon which the logic moves to block 34 to locate a new, non-congested blade, perhaps in the second blade center 16, that preferably is substantially identical to the congested “old” blade. When such a “new” blade is found at block 36, the above-mentioned transfer command is sent to the “old” blade to cause it to freeze the client computer (or at least the portions of the client that relate to servicing by the blade) and to send the payroll message. If desired, a status message indicating that the client has been frozen may be sent to the client computer. By “frozen” is meant that no further interaction is permitted between the client computer and congested blade, such that the congested blade is not altered in any way in respect of the client computer 12.

FIG. 5 shows the logic that may be followed by the “new” blade located at block 34 in FIG. 4. Commencing at block 38, the payroll information is received and loaded. At block 40, the “new” blade uses the payroll information to reconstruct the old DASD (memory) state of the congested “old” blade with respect to the client computer 12. In other words, the exact state of the “old”, congested blade with respect to the client computer 12 is reconstructed on the “new” blade, with the “new” blade being pointed to the proper location in the client computer's virtual storage by virtue of the pointer sent in the payroll. The “new” blade then authenticates the client computer if desired and resumes service to the client computer 12 using the IP address that was sent in the payroll.

While the particular SYSTEM AND METHOD FOR CLIENT REASSIGNMENT IN BLADE SERVER as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A method for transferring service of a client computer from a first blade server to a second blade server, comprising:
sending, from the first blade server, at least a client computer identifier and storage information pertaining to the client computer to the second blade server; and
at the second blade server, using the storage information and client computer identifier to resume service to the client computer.

2. The method of claim 1, comprising freezing the client computer and first blade server, prior to the sending act.

3. The method of claim 1, wherein the method is executed at least when the first blade server becomes congested as determined by at least one of: a data rate, and total bytes stored, or when blade failure is imminent.

4. The method of claim 1, wherein the second blade server is substantially identical in construction to the first blade server.

5. The method of claim 2, comprising sending to the client computer a status message that it is been frozen.

6. The method of claim 1, wherein the storage information includes Direct Access Storage Device information from the first blade server.

7. The method of claim 1, wherein the storage information includes a pointer to a virtual storage associated with the client computer and an exact memory map in the first blade server, the memory map being associated with the client computer.

8. The method of claim 7, wherein the client computer identifier includes an IP address of the client computer.

9. The method of claim 8, wherein the second blade server uses the storage information to reconstruct, at the second blade server, a data storage state of the first blade server with respect to the client computer.

10. A computer system, comprising:
at least a first blade server servicing a client computer;
at least a second blade server to which it is sought to transfer servicing of the client computer; and
logic for reconstructing, on the second blade server, the exact state of the first blade server with respect to the client computer, with the second blade server being pointed to a location in a virtual memory associated with the client computer, whereby the second blade server can assume, from the first blade server, servicing of the client computer.

11. The system of claim 10, wherein the logic for reconstructing uses storage information sent from the first blade server to the second blade server.

12. The system of claim 11, wherein the storage information includes Direct Access Storage Device information from the first blade server.

13. The system of claim 12, wherein the storage information includes a pointer to a virtual storage associated with the client computer and an exact memory map in the first blade server, the memory map being associated with the client computer.

14. The system of claim 10, wherein the second blade server is substantially identical in construction to the first blade server.

15. A service for transferring the servicing of a client computer from a first blade server to a second blade server, comprising:
providing means for sending storage information and client information from the first blade server to the second blade server;
providing means for using the storage information and client information to reconstruct, on the second blade server, the exact state of a client computer-dedicated portion with respect to the first blade server; and
providing means for establishing a service communication link between the client computer and the second blade server.

16. The service of claim 15, wherein the client information includes an IP address.

17. The service of claim 15, wherein the second blade server is substantially identical in construction to the first blade server.

18. The service of claim 15, wherein the storage information includes Direct Access Storage Device information from the first blade server.

19. The service of claim 15, wherein the storage information includes a pointer to a virtual storage associated with the client computer and an exact memory map in the first blade server, the memory map being associated with the client computer.
